(19) United States
(12) Patent Application Publication
(10) Pub. No.: US 2016/0372775 A1
(43) Pub. Date: Dec. 22, 2016

(54) Method for Temporarily Storing the Electric Energy of an Energy Supply System and Regenerative Energy Storage Device

(71) Applicant: ROBERT BOSCH GMBH, Stuttgart (DE)

(72) Inventors: Dietmar Steiner, Welzheim (DE); Kai Weeber, Heimsheim (DE); Annika Utz, Stuttgart (DE)

(73) Assignee: Robert Bosch GMBH, Stuttgart (DE)

(21) Appl. No.: 15/111,097

(22) PCT Filed: Dec. 9, 2014
(86) PCT No.: PCT/EP2014/077023

§ 371 Date: Jul. 12, 2016

(30) Foreign Application Priority Data
Jan. 13, 2014 (DE) 102014200385.7

(51) Int. Cl. H01M 8/18; H02J 15/00; C25B 1/00; H02J 3/38; C25B 1/04; C25B 15/08

(52) U.S. Cl. CPC H01M 8/186; C25B 1/04; C25B 15/08; C25B 1/003; H02J 3/383; H02J 15/00; H02J 3/387; H01M 2250/30

(57) ABSTRACT

The disclosure relates to a method for temporarily storing the electric energy of an energy supply system. The method comprises the steps: receiving the electric energy via an interface to the energy supply system; carrying out electrolysis in order to convert the electric energy into chemical reaction energy and an oxidant; and storing the chemical reaction energy in a fluid reservoir.

### PRIOR ART

The present invention relates to a method for temporarily storing electrical energy of an energy supply system, and to a regenerative energy storage device.

At present, photovoltaic systems (PV system) on roofs of residential buildings provide a large amount of electricity in the middle of the day, whereas the main consumption of electricity occurs in the evening. This has the effect that, in the case of the normal systems, without an electricity storage system, the proportion of internal consumption (internal consumption relative to photovoltaic yield) and the proportion of on-site coverage (on-site coverage relative to household consumption) are rather small. This means that large amounts of electricity are fed into the grid over the day, and electricity is purchased in the evening or at night.

### DISCLOSURE OF THE INVENTION

Against this background, the approach presented here presents a method for temporarily storing electrical energy of an energy supply system and, furthermore, a regenerative energy storage device, according to the main claims. Advantageous developments are given by the respective dependent claims and the description that follows.

Electrolysis can be used to convert electrical energy into chemical reaction energy, and the chemical reaction energy can be stored in a fluid reservoir, which can be easily altered an adapted in size. Such a system does not require any special storage strategies to protect the fluid reservoir. Advantageously in this case, disassociation of the reservoir volume and the reservoir output is achieved.

A method for temporarily storing electrical energy of an energy supply system is presented, wherein the method has the following steps:

receiving the electrical energy via an interface to the energy supply system;

performing electrolysis in order to convert the electrical energy into chemical reaction energy and an oxidant; and

storing the chemical reaction energy in a fluid reservoir.

An energy supply system may he understood to be a system that uses renewable energy for generating electricity, or for generating electricity and heat. Renewable energy in this case may be understood to mean, for example, water power, wind power, solar energy or geothermal heat. The electrical energy may be understood to mean electricity. In the step of performing the electrolysis, the electrical energy may force a redox reaction. In this case, some of the electrical energy may be converted into chemical energy. Some of the electrical energy may be converted into heat. In the step of performing the electrolysis, an auxiliary agent or starting material such as, for example, water, may be used to force the redox reaction by use of the electrical energy.

In the step of receiving, the electrical energy may be received via an interface to a photovoltaic system, as an energy supply system. Thus, electrical energy generated by a photovoltaic system can be converted into chemical energy and stored as such in a fluid reservoir.

Further, in a step of generating, the electrical energy may be generated by use of the photovoltaic system. Thus, solar energy can be used to generate electrical energy.

It is also favorable if the method comprises a step of converting the chemical reaction energy into reconverted electrical energy, and a step of providing the reconverted electrical energy. Advantageously, the generation of electrical energy and the consumption of electrical energy can be disassociated with respect to time. Heat can be generated in the step of converting the chemical reaction energy into reconverted electrical energy.

In the step of converting, a reaction of the chemical reaction energy and of the oxidant can be produced in a fuel cell in order, in the step of providing, to provide reconverted electrical energy and additionally, or alternatively, heat generated in the fuel cell.

In the step of providing, the reconverted electrical energy can be provided at an interface to a public electricity grid and additionally, or alternatively, to a domestic electricity supply network. The reconverted electrical energy can thus be consumed by the household itself, or the reconverted electrical energy can be fed into a public electricity grid. Demand fluctuations or imbalances between generation and consumption of electrical energy can thus be balanced out.

In the step of receiving, the electrical energy can be received via an interface to a public, local or privately owned electricity grid. The electrical energy can thus be received from the public electricity grid at times of over-supply or at times when prices are particularly low. A demand for electricity can thus be covered in a cost-effective manner. The grid stability of the public electricity grid can thus be improved.

Further, in the step of performing the electrolysis, water can be split into hydrogen and oxygen, and additionally, or alternatively, heat produced as the electrolysis is performed can be provided.

Advantageously, in the step of storing, the chemical reaction energy, the oxidant and, additionally or alternatively, the heat generated in the performing of the electrolysis, can be stored. In a special embodiment, in the step of storing, hydrogen, and additionally oxygen and additionally, or alternatively, heat, can be stored. Also, in the step of storing, the water produced in the step of converting the chemical reaction energy into reconverted electrical energy can be stored. If hydrogen, oxygen and water are stored, a closed circuit can be produced.

A regenerative energy storage device for an energy supply system is presented, wherein the regenerative energy storage device has the following features:

an interface for receiving electrical energy of the energy supply system;

an electrolysis means for converting the electrical energy into chemical reaction energy and an oxidant; and

a storage means for storing the chemical reaction energy in a fluid reservoir.

An electrolysis means may be understood to mean an electrolyzer. The electrolysis means may be used as a controllable load for grid stabilization. The chemical reaction energy may be generated as a fluid, in particular gaseous. The oxidant may be generated as a fluid. In the storage means, which may be realized as a fluid reservoir, the chemical reaction energy and the oxidant may be stored separately from each other.

The regenerative energy storage device may have a fuel cell for converting the chemical reaction energy into reconverted electrical energy and an interface for providing the reconverted electrical energy. A buffer storage for the electrical energy can thus be created.

A variant of the regenerative energy storage device may be applied or used for storing and additionally, or alternatively, for buffering electrical energy for a house.

The approach presented here additionally creates a device realized to perform, or implement, the steps of a variant of a method presented here in corresponding means. The object on which the invention is based can also be achieved in a rapid and efficient manner by this embodiment of the invention in the form of a device.

Advantageously, an aspect of the inventive idea presented here creates an increase in the proportion of on-site coverage of a building equipped with a regenerative energy storage device and a photovoltaic system, by use of a large energy storage system. This is financially useful against the background of falling or discontinuing support for fed-in electricity. At the same time, utilization of heat becomes possible, and consequently cost reduction in overall energy consumption becomes possible (electricity-to-electricity and electricity-to-heat). Numerous concepts are conceivable for utilization of the electricity and heat, such as, for instance, permitting energy suppliers to utilize the electrical storage system with cost-free heat for the household. Advantageously, deferred feed-in of electricity, at times of higher feed-in prices, can also become possible. One aspect, also, is the possibility of grid stabilization through the use of many small, decentralized energy storage systems, as an alternative to large central storage systems.

The approach presented here is explained exemplarily in greater detail in the following, on the basis of the appended drawings. There are shown in:

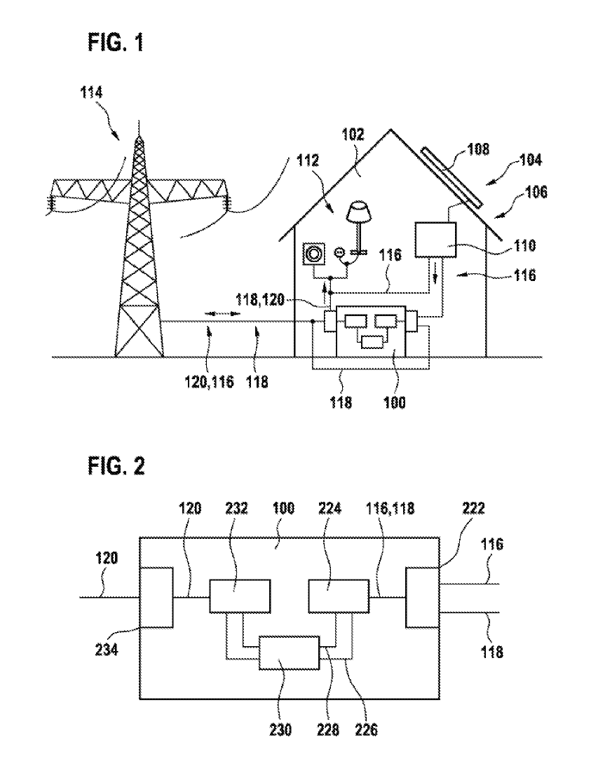

FIG. 1 a schematic representation of a regenerative energy storage device, in a house having an energy supply system, according to an exemplary embodiment of the present invention;

FIG. 2 a block diagram of a regenerative energy storage device according to an exemplary embodiment of the present invention;

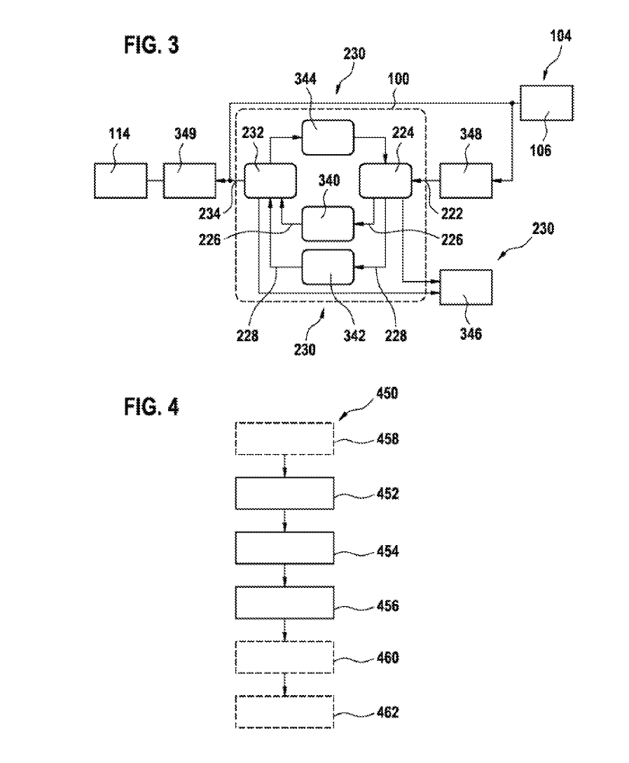

FIG. 3 a block diagram of a regenerative energy storage device according to an exemplary embodiment of the present invention; and

FIG. 4 a sequence diagram of a method according to an exemplary embodiment of the present invention.

In the following description of favorable exemplary embodiments of the present invention, elements, represented in the differing figures, that are similar in function are denoted by the same or similar references, and description of these elements is not repeated.

FIG. 1 shows a schematic representation of a regenerative energy storage device 100, in a house 102 having an energy supply system 104, according to an exemplary embodiment of present invention. According to this exemplary embodiment, the house 102 has a regenerative energy supply system 104, which, in the exemplary embodiment shown, is realized as a photovoltaic system 106, consisting of at least one solar module 108 and an inverter 110. The house 102, which may also be referred to as a household 102, has electrical consumers 112. Furthermore, the house 102 has a regenerative energy storage device 100. The regenerative energy storage device 100 may be referred to as a fuel-cell storage device or as a regenerative energy storage system.

As shown in greater detail in FIG. 2 and FIG. 3, the regenerative energy storage device 100 has at least one interface for receiving electrical energy 116, 118, an electrolysis means and a storage means. The house 102, or the regenerative energy storage device 100, is connected to a public electricity grid 114 via a line and a corresponding interface. Electrical energy 118, which, depending on the situation, is routed to the interface for receiving electrical energy of the regenerative energy storage device 100 or to the electrical consumers 112, is drawn from the electricity grid 114. Electrical energy 120 reconverted by the regenerative energy storage device 100 is fed into the public electricity grid 114 or routed to the electrical consumers 112. For this purpose, the regenerative energy storage device 100 has a corresponding control device, in order to route the flows of electricity.

The photovoltaic system 106 is designed to provide electrical energy 116 to the regenerative energy storage device 100 and additionally, or alternatively, to the electrical consumers 112. The public electricity grid 114 provides electrical energy to the house 102, or household 102. Optionally, the public electricity grid, as represented in the exemplary embodiment in FIG. 1, is realized such that electrical energy from the photovoltaic system 106 and from the regenerative energy storage device 100 can be fed directly into the public electricity grid 114.

The regenerative energy storage device 100 is also referred to as a regenerative fuel cell system 100, as an electricity storage system in residential buildings 102. In the case of a current support policy, the owner of a photovoltaic system 106 receives a fixed price for fed-in electricity 116, 120 (depending on the time at which the system was put into operation). In Germany, however, the price drops with the quantity of installed power. Moreover, in 2012 an internal consumption bonus was introduced, according to which, currently, a maximum of only 90% of the generated amount of electricity is still remunerated, in order to create an incentive for greater internal use. Generally, support runs over a period of 20 years. The price that can be achieved for solar electricity 120 following expiry of the support is not foreseeable, but is probably low, since in sunny conditions there will be an excess of electricity 120 available for feed-in. It is therefore sensible, from that point in time, at the latest, either to consume the produced electricity 116 internally or, by means of temporary storage, to feed-in the electricity 120 at times when a high electricity price can be achieved, which can additionally result in stabilization of the electricity grid 114. As already described above, in the exemplary embodiment shown the photovoltaic system 106 is connected to the public electricity grid 114, in order to feed produced electricity into the public electricity grid 114 additionally, or alternatively, without being diverted via the regenerative energy storage device 100.

For this reason, there is an increasing offer of storage systems for photovoltaic systems (104). An advantage of the regenerative energy storage device 100 shown here is the simple scalability of the size of the storage system. The regenerative energy storage device 100 offers the possibility of implementing a day-night balancing of the electricity demand and contributes towards an increase in on-site coverage. Moreover, in comparison with a battery based solution, a larger and more scalable storage system is possible. The parameters storage capacity, maximum charging capacity and maximum discharging capacity are freely configurable without compromises between the parameters. A high proportion of on-site coverage is therefore possible for the household if large storage system sizes (storage capacity) are available. Thus, over and above day-night balancing, it is also possible, advantageously, to achieve a supply in weeks in which there is little sun.

One exemplary embodiment of the regenerative energy storage device 100, as a regenerative fuel cell system, by disassociating storage volume and storage capacity, provides for selective adaptation to the local conditions (electricity consumption of the household, photovoltaic output). Additional storage capacity, for example in the form of gas cylinders, is comparatively favorable. The optional disassociation of charging capacity and discharging capacity is achieved by use of an electrolyzer for charging, and of a fuel cell for discharging the storage system. The avoidance of complicated storage strategies means that a simple system can be realized. In this case, the maintenance of particular charge states and current intensities is not crucial for the service life of the system. Moreover, based on current knowledge, the regenerative fuel cell system 100 does not have cycle-dependent ageing. In this case, an exemplary embodiment of the regenerative energy storage device 100 creates combined utilization of electricity and heat. This is useful, in particular, in the case of low feed-in prices but high gas costs.

FIG. 2 shows a block diagram of a regenerative energy storage device 100 for providing regenerative energy storage for a regenerative energy supply system according to an exemplary embodiment of the present invention. The regenerative energy supply system may be an exemplary embodiment of the regenerative energy supply system denoted by the reference 104 in FIG. 1. The regenerative energy storage device 100 comprises at least one interface 222 for receiving electrical energy 116 of the regenerative energy supply system and additionally, or alternatively, electrical energy 118 from an electricity grid, an electrolysis means 224 for converting the electrical energy 116, 118 into chemical reaction energy 226 and an oxidant 228, and a storage means 230 for storing at least the chemical reaction energy 226. In one exemplary embodiment, the storage means 230 is a fluid reservoir 230. The chemical reaction energy 226 is generated as a fluid.

In the exemplary embodiment shown in FIG. 2, the regenerative energy storage device 100 comprises a fuel cell 232 for converting the chemical reaction energy 226 into reconverted electrical energy 120. Furthermore, the regenerative energy storage device 100 comprises an interface 234 for providing the reconverted electrical energy 120. In this case, the fuel cell 232 can convert the reconverted electrical energy 120 by use of the chemical reaction energy 226 and the oxidant 228. In this case, in a variant of the exemplary embodiment presented here, the chemical reaction energy 226 is hydrogen and the oxidant 228 is oxygen. Depending on the exemplary embodiment, or situation, the reconverted electrical energy 120 is fed into an electricity grid or provided to a household or fed into a public electricity grid. Not shown is a power electronics unit. It may be necessary in this case to provide a power electronics unit. A corresponding exemplary embodiment is shown in FIG. 3. The latter shows two power electronics units, denoted by the references 348 and 349.

In an exemplary embodiment that is not shown, the electrolyzer 224 has an interface for receiving water. Furthermore, in the exemplary embodiment that is not shown, the fuel cell 232 has an interface for providing water. In the electrolyzer 224, by use of the electrical energy 116, the water can be split into hydrogen and oxygen. In the fuel cell 232, the reverse process, by a reaction of hydrogen and oxygen, can produce reconverted electrical energy 120 and water. In both processes, i.e. in the electrolyzer 224 and in the fuel cell 232, heat is additionally produced, which is provided to a corresponding interface.

FIG. 3 shows a block diagram of a regenerative energy storage device 100 for providing regenerative energy storage according to an exemplary embodiment of the present invention. The regenerative energy storage device 100 may be an exemplary embodiment of a regenerative energy storage device 100 shown and described in FIG. 1 or FIG. 2. The regenerative energy storage device 100 comprises an electrolysis unit 224, a fuel cell unit 232, an interface 222 to the energy supply system 104, or to the photovoltaic system 106, an interface 234 to an electricity grid 114, and a storage means 230. The storage means 230 is divided into a hydrogen reservoir 340, an oxygen reservoir 342, a water tank 344 and, outside the regenerative energy storage device 100, a heat accumulator 346. In both running processes, i.e. in the process running in the electrolyzer 224 and in the process running in the fuel cell 232, resultant heat can be extracted. The photovoltaic system 106 is connected to the interface 222 to the regenerative energy supply system 104 via first power electronics unit 348. The electricity grid 114 is connected to the interface 234 to the public electricity grid 114 via a second power electronics unit 349.

The electrolysis means 224, also referred to as an electrolyzer 224, is designed to convert, electrical energy and water, as starting material or auxiliary agent, into chemical reaction energy 226 and an oxidant 228. The chemical reaction energy 226 and the oxidant 228 are present in the form of a fluid, for example a gas. In the exemplary embodiment shown in FIG. 3, the chemical reaction energy 226 is present in the form of hydrogen (H₂) and the oxidant 228 in the form of oxygen (O₂). In general terms, the chemical reaction energy 226 is stored in a reservoir 340 for chemical reaction energy 226 and the oxidant 228 is stored in a reservoir 342 for an oxidant 228. In the execution of the process in the electrolyzer 224, heat, or thermal energy, is additionally released.

The heat produced in the electrolysis means 224 and in the fuel cell unit 232 is routed to the heat accumulator 346, and from there it can be used as heating energy or for heating service water.

In other words, the regenerative fuel cell system 100 presented here, as an electricity storage system in residential buildings, consists of the following components: an electrolysis unit 224 for splitting water into hydrogen 226 and oxygen 228, and for heat utilization by use of, for example, the electricity of the photovoltaic system 106, a fuel cell unit 232 for conversion back into electricity and for generation of heat by use of the hydrogen 226 and the oxygen 228 produced in the electrolysis unit 224, a respective gas reservoir 340, 342 for hydrogen 226 and oxygen 228, and a water tank 344 for deionized water. Optionally, an exemplary embodiment that is not shown has an additional compression unit, for compressing the fluids (gases). The required fluid reservoir can thus be of a lesser volume.

By way of example, a system configured with a 3 kW-electrolyzer 224 and two 50-litre tanks 340 at 350 bar gives a storage capacity of 75 kWh hydrogen (2.3 kg). Upon reconversion to electricity in the fuel cell 232, >40 kWhₑₗ is produced. In this case, the system 100 also comprises a 50-litre oxygen tank 342 (likewise 350 bar) and an approximately 20-litre water tank 344.

In the case of surplus power from the photovoltaic system 106, electricity is used in the electrolysis unit 224 to produce hydrogen 226 and oxygen 228, which can be stored for any length of time in the two gas tanks 340, 342. In this case, the reservoir pressure is ideally matched to the pressure level of the electrolyzer 224, thereby saving the expenditure of energy for additional compression. In addition, it is possible to use the waste heat of the electrolyzer 224, for example for producing hot water. If there is demand for electricity in the household or in the grid, the gases 226, 228 (H₂ and O₂) are converted back to electricity, forming water, which is again stored in the water tank 344. In this process step, also, utilization of heat is possible.

The system is ideally realized as a closed system, thereby enabling operation without additional water conditioning or gas purification.

If stacks are available, enabling both electrolysis operation and fuel cell operation (reversible fuel cell), it is possible to reduce the structural space. The size of the gas reservoirs 340, 342 can be adapted in any way (since non-dependent on electrolysis capacity and fuel cell capacity), and consequently provides for ideal adaptation to the consumption profile and the available photovoltaic output.

Several operating concepts are conceivable for the system presented. In the case of on-site supply to a dwelling, a high proportion of on-site coverage is made possible by the large storage system. In particular, power balancing is possible, over and above day-night balancing. Moreover, grid stabilization can be achieved. The storage system makes it possible to install larger photovoltaic systems 106 per dwelling, which go beyond internal consumption and enable these dwellings to feed electrical energy into the grid from the storage system in times of low photovoltaic output. This becomes particularly attractive in the case of a time-dependent remuneration. In a further scenario, an energy supplier obtains access to the storage system and to the charging/discharging strategy for a remuneration, and waste heat can be utilized locally. This enables the regenerative energy storage device 100 to be used specifically for stabilization of the electricity grid 114. One aspect of the inventive idea presented is a long-term storage system with potential for long-term storage by decentralized distribution of a plurality of small unit.

The exemplary embodiment in FIG. 3 shows, as one aspect, a diagram of the linking of a regenerative fuel cell system 100, consisting of electrolysis 224 and fuel cell unit 232 and reservoirs 340, 342, 344 for hydrogen, oxygen and water, to the photovoltaic system 106, the connection to the electricity grid 114 and a connection to the local heat accumulator 346 of the dwelling.

FIG. 4 shows a sequence diagram of a method 450 for temporarily storing electrical energy for a regenerative energy supply system according to an exemplary embodiment of the present invention. The energy supply system may be a variant of the regenerative energy supply system 104 shown in FIG. 1. The method 450 comprises a step 452 of receiving the electrical energy via an interface to the regenerative energy supply system, a step 454 of performing electrolysis in order to convert the electrical energy into chemical reaction energy and an oxidant, and a step 456 of storing the chemical reaction energy in a fluid reservoir. The chemical reaction energy is generated as a fluid.

In the variant shown here, the method 450 has an optional step 458 of generating the electrical energy by use of the photovoltaic system. Furthermore, the method 450 has an optional step 460 of converting the chemical reaction energy into reconverted electrical energy, and an optional step 462 of providing the reconverted electrical energy. In this case, the reconverted energy can be supplied to the public electricity grid and additionally, or alternatively, to the domestic electricity supply network.

In one exemplary embodiment, in the step 454 of performing electrolysis and in the optional step 460 of converting the chemical reaction energy, heat is generated, which can be used in the household, or stored in an accumulator, or fed into a district heating system.

The exemplary embodiments described and shown in the figures have been selected merely by way of examples. Differing exemplary embodiments may be combined with one another, in their entirety or in respect of individual features. An exemplary embodiment may also be supplemented by features of another exemplary embodiment.

Further, the method steps presented here can be repeated and performed in a sequence other than that described.

If an exemplary embodiment includes an “and/or” link between a first feature and a second feature, this is to be construed such that the exemplary embodiment according to one embodiment has both the first feature and the second feature, and according to a further embodiment has either only the first feature or only the second feature.

1. A method for temporarily storing electrical energy of an energy supply system, the method comprising:
receiving the electrical energy via a first interface from the energy supply system;
performing electrolysis to convert the electrical energy into chemical reaction energy and an oxidant; and
storing the chemical reaction energy in a fluid reservoir.

2. The method as claimed in claim 1, the receiving of the electrical energy further comprising:
receiving the electrical energy via the first interface from a photovoltaic system.

3. The method as claimed in claim 2, further comprising:
generating the electrical energy using the photovoltaic system.

4. The method as claimed in claim 1, further comprising:
converting the chemical reaction energy into reconverted electrical energy; and
providing the reconverted electrical energy.

5. The method as claimed in claim 4, wherein:
the converting of the chemical reaction energy further comprises producing a reaction of the chemical reaction energy and of the oxidant in a fuel cell; and
the providing of the reconverted electrical energy further comprising at least one of (i) providing the reconverted electrical energy generated in the fuel cell and (ii) providing heat generated in the fuel cell.

6. The method as claimed in claim 4, the providing of the reconverted electrical energy further comprising:
providing the reconverted electrical energy via second interface to at least one of a public electricity grid, a local electricity grid, a privately owned electricity grid, and a domestic electricity supply network.

7. The method as claimed in claim 1, the receiving of the electrical energy further comprising:
receiving the electrical energy via the first interface from a public electricity grid.

8. The method as claimed in claim 1, the performing of the electrolysis further comprising at least one of:
splitting water into hydrogen and oxygen; and
providing heat produced as the electrolysis is performed.

9. The method as claimed in claim 1, the storing of the chemical reaction energy further comprising:
storing at least one of the chemical reaction energy produced as the electrolysis is performed, the oxidant produced as the electrolysis is performed, and heat produced as the electrolysis is performed.

10. The method as claimed in claim 1, further comprising:
utilizing of heat in operation of a fuel cell.

11. A regenerative energy storage device for an energy supply system, the regenerative energy storage device comprising:
a first interface configured to receive electrical energy from the energy supply system;
an electrolysis device configured to convert the electrical energy into chemical reaction energy and an oxidant; and
a storage device configured to store the chemical reaction energy.

12. The regenerative energy storage device as claimed in claim 11, further comprising:
a fuel cell configured to convert the chemical reaction energy into reconverted electrical energy; and
a second interface configured to provide the reconverted electrical energy.

13. The regenerative energy storage device as claimed in claim 11, wherein the regenerative energy storage device is configured to at least one of store and buffer electrical energy for a house.
